(19) United States
(12) Patent Application Publication
(10) Pub. No.: US 2007/0276109 A1
(43) Pub. Date: Nov. 29, 2007

(54) Porous Nano Material Polymer Composite

(75) Inventors: Takashi Sawaguchi, Tokyo (JP); Shoichiro Yano, Tokyo (JP); Toshiki Hagiwara, Tokyo (JP); Mitsuko Ito, Tokyo (JP)

Correspondence Address: OHLANDT, GREELEY, RUGGIERO & PERLE, LLP, ONE LANDMARK SQUARE, 10TH FLOOR, STAMFORD, CT, 06901, US

(73) Assignee: NIHON UNIVERSITY, CHIYODA-KU, TOKYO (JP)

(21) Appl. No.: 10/591,506

(22) PCT Filed: Mar. 4, 2005
(86) PCT No.: PCT/JP05/03748

§ 371 Date: Jun. 26, 2007

(30) Foreign Application Priority Data
Mar. 8, 2004 (JP) 2004-064280

(51) Int. Cl. C08F 20/14; B82B 1/00; B82B 3/00; C08F 2/04; C08F 2/44

(52) U.S. Cl. 526/329.7; 977/890

(57) ABSTRACT

The invention relates to a porous nano material polymer composite. The porous nano material polymer composite according to the invention is prepared by impregnating monomer in the nanometer order holes of a nano material by supercritical carbon dioxide fluid, and by polymerizing the monomer in situ. Therefore, the polymer composite has a network structure in which polymer penetrates into nano pores.

### FIELD OF THE INVENTION

The invention relates to a porous nano material polymer composite and manufacturing methods of the same.

### BACKGROUND OF THE INVENTION

Research and development of hybrid materials comprising polymer and various inorganic materials has long been underway. The materials developed so far were manufactured by mixing base polymer and inorganic materials. Therefore, the resulting material has a structure in which the inorganic material is scattered in the base polymer as a matrix, or a structure in which the islets of the inorganic material are mixed in the base polymer in macro order (or semi micro order). Therefore, the physical properties of the resulting hybrid are little different from those of the base polymer.

Recently, hybrid materials are widely used in various fields, and development of novel material having remarkably novel physical properties is expected. Unfortunately, any of existing hybrid materials cannot satisfy these needs.

### SUMMARY OF THE INVENTION

### Problems to be Solved by the Invention

The purpose of the invention is to provide a polymer composite of novel polymer/nano silica hybrid material using a porous inorganic nano material and organic polymer, wherein the polymer composite has a structure in which polymer penetrates into the nano pores of the nano material to form a network structure.

### Means for Solving the Problems

In order to satisfy expectations as above, the inventor devoted himself to the research and development of a hybrid material having a novel structure with novel functions that would be useful in a variety of technical fields. As a result, the inventor found that a polymer composite having a network structure can be manufactured in which polymer penetrates into the nano pores. The invention was completed based on this finding.

That is, the invention is a novel polymer/nano silica hybrid material using a porous inorganic nano material and organic polymer, wherein the polymer composite nano material has a structure in which polymer penetrates into the nano pores of the nano material to form a network.

Another aspect of the invention is a hybrid material wherein the porous inorganic nano material is nano silica, and the polymer is polymethyl methacrylate (PMMA), and wherein the hybrid material has high clarity, high heat resistance, and high hardness.

Another aspect of the invention is manufacturing methods of the hybrid material as above, wherein the method comprises impregnating monomer in holes in nanometer order of the nano inorganic material in supercritical carbon dioxide fluid, and polymerizing the monomer in situ. By this manufacturing method, a polymer composite nano material having a novel structure in which a variety of polymers penetrate into the nano pores of a variety of inorganic nano materials to form a network structure can be obtained.

### Advantage of the Invention

The manufacturing method of the polymer/nano silica hybrid material according to the invention comprises impregnating monomer in nanometer order holes of the nano material in supercritical carbon dioxide fluid, and polymerizing the monomer in situ. Therefore, the resulting hybrid material has a novel structure in which the polymer penetrates into the nano pores of the inorganic nano material to form a network structure.

Therefore, the hybrid material according to the invention features excellent properties (for example, when PMMA as polymer and nano silica are used, a hybrid material having high clarity, high heat resistance, and high hardness can be obtained).

### BRIEF DESCRIPTION OF THE DRAWINGS

FIG. 1 is a graph which shows molecular weight (Mn), molecular weight distribution (Mw/Mn), yield (%), nano silica content (observed content and calculated content wt %), and TG measurement curve of PMMA manufactured without nano silica under experiment conditions used in embodiment 1, and that of the hybrids containing nano silica 5 wt % manufactured according to embodiments 1 and 3 (1), respectively.

FIG. 2 is a graph which shows molecular weight (Mn), molecular weight distribution (Mw/Mn), yield (%), nano silica content (observed content and calculated content wt %), and DMA measurement curve of PMMA manufactured without nano silica under experiment conditions used in embodiment 1, and that of the hybrids containing nano silica 5 wt % manufactured according to embodiments 1 and 3 (1), respectively.

FIG. 3 is a graph which shows molecular weight (Mn), molecular weight distribution (Mw/Mn), yield (%), nano silica content (observed content and calculated content wt %), and TG measurement curve of PMMA manufactured without nano silica under experiment conditions used in embodiment 1, and that of hybrids containing nano silica 5 wt % manufactured according to embodiments 2, 3 (2), and 4, respectively.

FIG. 4 is a graph which shows molecular weight (Mn), molecular weight distribution (Mw/Mn), yield (%), nano silica content (observed content and calculated content wt %), and DMA measurement curve of PMMA manufactured without nano silica under experiment conditions used in embodiment 1, and that of hybrids containing nano silica 5 wt % manufactured according to embodiments 2, 3 (2), and 4, respectively.

FIG. 5 is a graph which shows molecular weight (Mn), molecular weight distribution (Mw/Mn), yield (%), nano silica content (observed content and calculated content wt %), and DMA measurement curve of PMMA manufactured without nano silica under experiment conditions used in embodiment 1, and that of hybrids containing nano silica 5 wt % manufactured according to embodiments 2, 3 (2), and 4, respectively.

FIG. 6 is a graph which shows molecular weight (Mn), molecular weight distribution (Mw/Mn), yield (%), nano silica content (observed content and calculated content wt %), and TG measurement curve of PMMA manufactured without nano silica under experiment conditions used in embodiment 5, and that of hybrids containing nano silica 50 wt % manufactured according to embodiments 5 and 7 (2), respectively.

FIG. 7 is a graph which shows molecular weight (Mn), molecular weight distribution (Mw/Mn), yield (%), nano silica content (observed content and calculated content wt %), and DMA measurement curve of PMMA manufactured without nano silica under experiment conditions used in embodiment 5, and that of hybrids containing nano silica 50 wt % manufactured according to embodiments 5 and 7 (2), respectively.

FIG. 8 is a graph which shows molecular weight (Mn), molecular weight distribution (Mw/Mn), yield (%), nano silica content (observed content and calculated content wt %), and TG measurement curve of PMMA manufactured without nano silica under experiment conditions used in embodiment 5, and that of hybrids containing nano silica 10 wt % manufactured according to embodiments 6, 7 (1) and 8, respectively.

FIG. 9 is a graph which shows molecular weight (Mn), molecular weight distribution (Mw/Mn), yield (%), nano silica content (observed content and calculated content wt %), and DMA measurement curve of PMMA manufactured without nano silica under experiment conditions used in embodiment 5, and that of hybrids containing nano silica 10 wt % manufactured according to embodiments 6, 7 (1) and 8, respectively.

### DETAILED DESCRIPTION OF THE INVENTION

Porous Nano Material Polymer Composite

The porous nano material polymer composite according to the invention is characterized in that the polymerized polymer molecules penetrate into and adjacent to the nanometer order holes of the nano inorganic material to form a network structure. The structure (hereinafter referred to as “the microstructure”) could have been theoretically assumed, but could not have been manufactured by any existing methods. Therefore, the structure has not been known in the art. The microstructure is significantly different from any of conventional microstructures that are manufactured by mixing polymer and nano materials. The difference will be demonstrated in the following description of the exemplary embodiments, that is, the microstructure according to the invention shows a thermodynamic behavior substantially different from mere mixture of same polymer content (molecular weight and molecular weight distribution) and nano silica material content.

There is no particular restriction on the porous nano material used in this invention provided that it has holes (pore) in nano order. A various materials are known to have such structure, including nano silica, nano alumina, carbon nanotube, and fullerene. The porous nano material can be selected depending on the matrix polymer to be used in combination, and required physical properties. When the polymer is PMMA, nano silica is preferably used. There is no particular restriction on the amount of the inorganic porous nano material. The amount can be determined depending on the matrix polymer to be used in combination, and required physical properties. When the polymer is PMMA, the content can be 0 to 90 wt % (preferably 5 to 50 wt %).

There is no particular restriction on the polymer used in this invention provided that the monomer thereof can be impregnated in the nano order holes (pores) of the above mentioned inorganic porous nano material in the supercritical fluid. A variety of monomers are known to have such property, including methacrylate, vinyl, and acrylate. The polymer can be selected depending on the inorganic porous nano material to be used in combination, and required physical properties. When the polymer is PMMA, nano silica is preferably used. It is also possible to use an appropriate combination of several monomers. The polymer can be selected depending on required physical properties. When the polymer is PMMA, the content can be 0 to 90 wt % (preferably 5 to 50 wt %).

The physical property values and the structure of the hybrid material according to the invention can be evaluated using a variety of measurement methods well known in the art (e.g., thermometric analyzer, dynamic mechanical analyzer, electron microscope). Also, based on these physical property values, the material can be molded and processed using a variety of processing method.

Manufacturing Methods

The porous nano material polymer composite according to the invention is characterized in that the polymer molecules penetrate into and adjacent to the nanometer order holes of the nano material to form a network structure. It was completely impossible to manufacture the microstructure as above by any of existing manufacturing methods.

The manufacturing method according to the invention comprises mixing a nano material and monomer under appropriate supercritical fluid condition, impregnating the monomer in nanometer order holes of the nano material, polymerizing the monomer in situ under the same supercritical condition, having the resulting polymer penetrate into the nanometer order holes of the nano material, to form network structure.

There is no particular restriction on the type and condition of the supercritical fluid used in the invention. Appropriate fluid and condition can be selected based on the properties of the nano material and polymer (monomer), and combination thereof used in the invention. Preferably, carbon dioxide (scCO₂) or ethane can be used as a supercritical fluid. Carbon dioxide is more preferable. There is no particular restriction on the supercritical conditions. Data on particular fluid can be preferably referred.

There is no particular restriction on a reaction container to be used in the invention. Ordinary type high-pressure reaction vessel is applicable. To the vessel, necessary amount of carbon dioxide can be introduced, monomer can be introduced under supercritical condition, and the carbon dioxide and the monomer can be mixed at appropriate temperature for appropriate duration. These temperature and duration can be selected based on the properties of the nano materials and polymer (monomer) and combination thereof used in the invention.

There is no particular restriction on impregnation conditions (pressure, temperature, duration) to be used in the invention. The conditions can be selected based on the combination of the inorganic nano materials and the monomer to be used. When fluid is one of carbon dioxide, nano silica, or methyl methacrylate, preferable impregnation conditions (pressure, temperature, duration) are 0.5-20 MPa, about 80° C., and about 24 hours.

Furthermore, there is no particular restriction on the condition of polymerization. Any polymerization conditions usable in the selected supercritical fluid and supercritical conditions (temperature, pressure) can be selected appropriately.

Preferably, radical polymerization can be performed under presence of a radical polymerization initiator which can start reaction at appropriate temperature. When fluid is one of carbon dioxide, nano silica, or methyl methacrylate, preferable polymerization conditions (temperature, pressure, polymerization initiator, reaction time) are 80° C., 7.5 MPa, AIBN, and 24 hours.

As a work-up of polymerization, the fluid is removed, the resulting polymer is filtered, and the polymer can be refined by removing monomer and polymer polymerized in the supercritical fluid using a suitable solvent. The solution in which the polymer is dissolved can be added to insoluble solvent to precipitate the polymer.

Next, the detail of the invention will be described with reference to specific embodiments.

### EXAMPLE 1

Manufacturing of PMMA/Nano Silica (5 wt %) Hybrid (PMMA/SiO₂(RX50) (scCO₂)) using Supercritical Carbon Dioxide (ScCO₂)

As nano silica, commercially available aerosil by Japan Aerosil Co., Ltd. (hydrophobic AEROSIL (RX50) hexamethyldisilazane treated, average primary particle diameter 40 nm) was used.

Methyl methacrylate (MMA) 3.0 g as monomer, dry nano silica (RX50) 0.15 g, and a radical initiator α,α′-azobisisobutyronitrile (AIBN) 0.0492 g were added in a supercritical reaction cell (volume 50 ml), agitated and impregnated at 40° C. under CO₂ 4 MPa for one hour. Temperature of the reaction cell was kept at 80° C. for polymerization under predetermined pressure for 24 hours. After reaction, the resulting reaction mixture was dissolved in acetone 100 ml, and dropped into hexane 300 ml. The resulting white sediment was filtered and collected, and dried under reduced pressure (40° C.) until reaching to a constant weight.

### EXAMPLE 2

Manufacturing of PMMA/Nano Silica (5 wt %) Hybrid (PMMA/SiO₂ (RX50) (Toluene)) using Toluene Solvent

MMA 3.0 g and dry nano silica 0.15 g, AIBN 0.0492 g, and toluene 10 ml were added in a reaction container, and reacted under nitrogen atmosphere (normal pressure) at 80° C. for 24 hours.

After reaction, the reaction mixture was dropped into hexane 200 ml. The resulting white sediment was filtered and collected, and dried under reduced pressure (40° C.) until reaching to a constant weight.

### EXAMPLE 3

Manufacturing of Blend (PMMA/SiO₂ (RX50) (Blend)) of PMMA/Nano Silica (5 wt %) Hybrid (PMMA/SiO₂) using Toluene Solvent

(1) PMMA 1.0 g of number average molecular weight 16.0×10⁴ polymerized in the experiment procedure (in scCO₂) of embodiment 1, and dry nano silica 0.05 g were added into solvent toluene 3.3 ml, and agitated for 24 hours at room temperature.

After reaction, the reaction mixture was dropped into hexane 100 ml, and precipitated. The resulting white sediment was filtered and collected, and dried under reduced pressure (40° C.) until reaching to a constant weight.

(2) PMMA 1.0 g of number average molecular weight 5.57×10⁴ polymerized in the experiment procedure (in toluene solvent) of embodiment 2, and dry nano silica 0.05 g were added into solvent toluene 3.3 ml, and agitated for 24 hours at room temperature.

After reaction, the reaction mixture was dropped into hexane 100 ml, and precipitated. The resulting white sediment was filtered and collected, and dried under reduced pressure (40° C.) until reaching to a constant weight.

### EXAMPLE 4

Manufacturing of PMMA/Nano Silica (5 wt %) Hybrid (PMMA/SiO₂(RX50) (Toluene-scCO₂) using Solvent Comprising scCO₂ and Solvent Toluene (2.5 ml, 5 ml, 10 ml Toluene was used)

MMA 3.0 g, dry nano silica 0.15 g, toluene 10 ml, and AIBN 0.0492 g were added in a supercritical reaction cell (volume 50 ml), agitated and impregnated at 40° C. under CO₂ 4 MPa for one hour, then polymerized at 80° C. under predetermined pressure for 24 hours. After reaction, the reaction mixture was dissolved in acetone 100 ml, and dropped into hexane 300 ml. The resulting white sediment was filtered and collected, and dried under reduced pressure (40° C.) until reaching to a constant weight.

Result 1

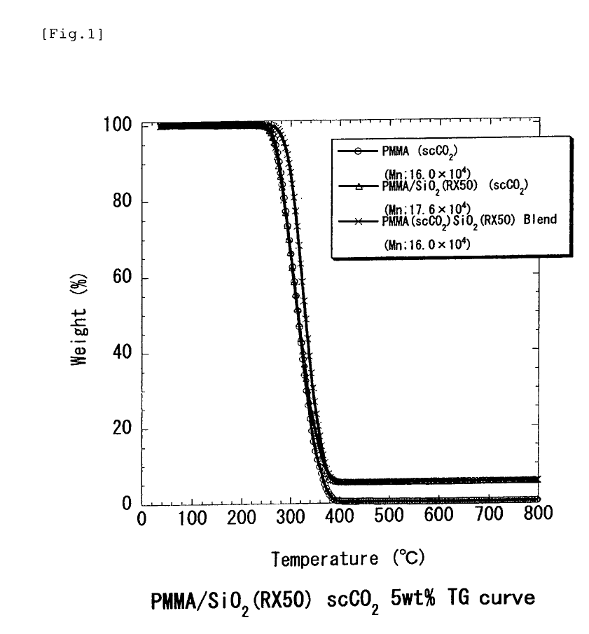

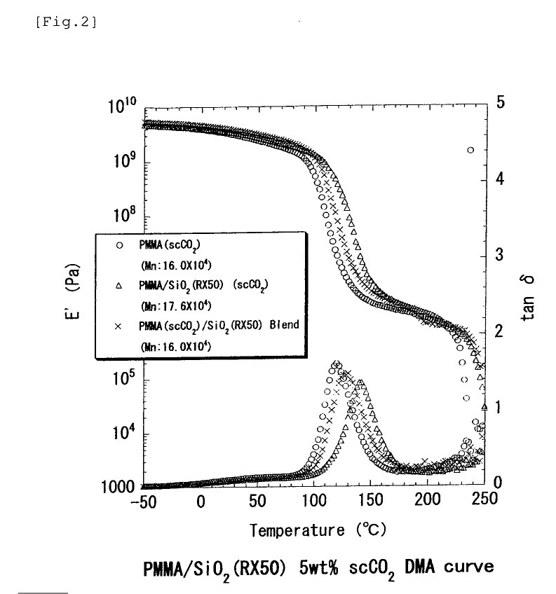

Table 1, and FIGS. 1 and 2 show the molecular weight (Mn), molecular weight distribution (Mw/Mn), yield (%), nano silica content (observed content and calculated content wt %), TG measurement curve and DMA measurement curve of PMMA manufactured without nano silica under experiment conditions used in embodiment 1, and those of hybrids containing nano silica 5 wt % manufactured according to embodiments 1 and 3 (1).

TABLE 1
Molecular weight and yield of resulting PMMA/silica hybrids
(PMMA/SiO₂(RX50) 5 wt % hybrids)

| | | | | Obserbed silica | Calculated silica |
|---|---|---|---|---|---|
| Sample | Mn × 10⁻⁴ | Mw/Mn | Yeild (%) | content (wt %) | content (wt %)¹⁾ |
| PMMA | 16.0 | 2.39 | 92.0 | — | — |
| (scCO₂) | | | | | |
| PMMA/SiO₂(RX50) | 17.6 | 1.79 | 90.6 | 5.28 | 5.1 |
| 5 wt % | | | | | |
| (scCO₂) | | | | | |
| PMMA(scCO₂)/ | 16.0 | 2.39 | 92.7 | 5.3 | 5.1 |
| SiO₂(RX50)5 wt % | | | | | |
| (Blend) | | | | | |

¹⁾100 × (freed silica weight/hybrid weight)

As can be seen in the table and figures, MMA was impregnated and polymerized in silica by the effect of scCO₂ and PMMA was generated.

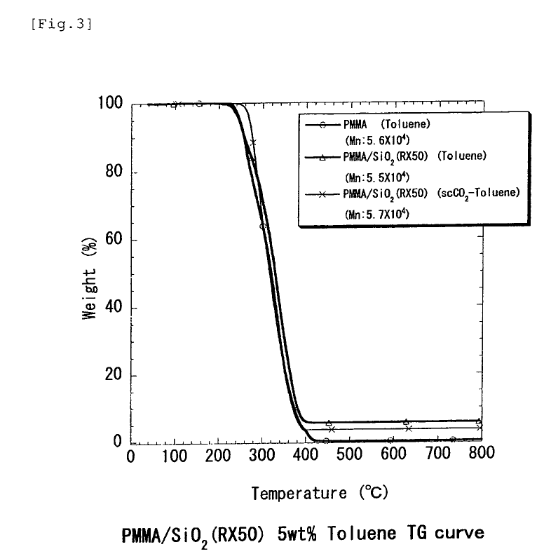

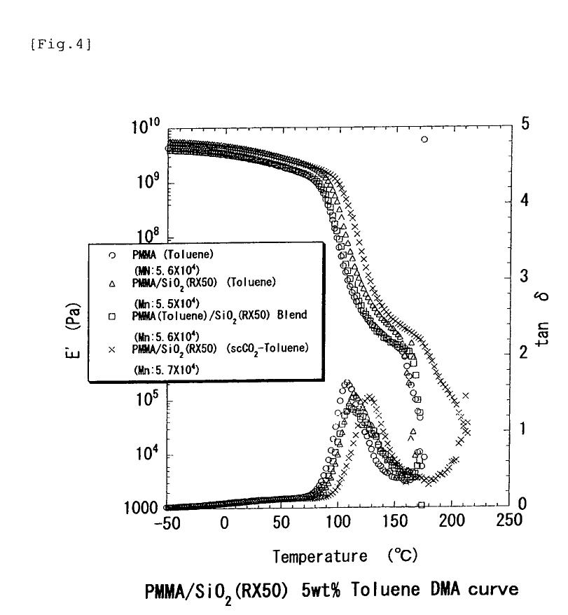

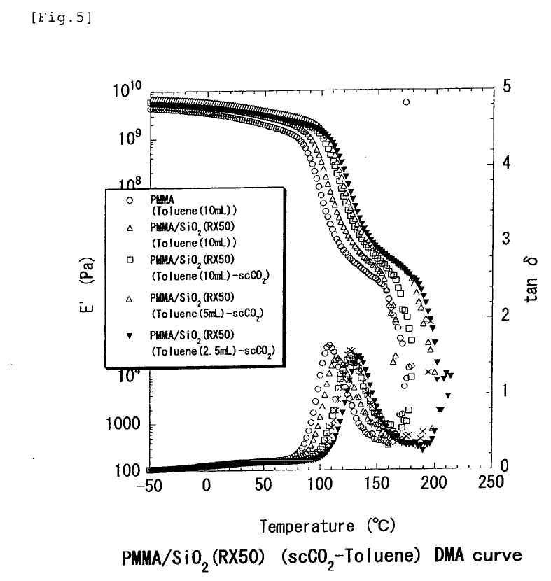

Tables 2 and 3, and FIGS. 3, 4 and 5 show the molecular weight (Mn), molecular weight distribution (Mw/Mn), yield (%), nano silica content (observed content and calculated content wt %), TG measurement curve and DMA measurement curve of PMMA manufactured without nano silica under experiment conditions used in embodiment 1, and those of hybrids containing nano silica 5 wt % manufactured according to embodiments 2, 3 (2) and 4.

TABLE 2
Molecular weight and yield of resulting PMMA/silica hybrids
(PMMA/SiO₂(RX50) 5 wt % hybrids)

| | | | | Obserbed silica | Calculated silica |
|---|---|---|---|---|---|
| Sample | Mn × 10⁻⁴ | Mw/Mn | Yeild (%) | content (wt %) | content (wt %)¹⁾ |
| PMMA | 5.57 | 1.80 | 73.45 | — | — |
| (Toluene) | | | | | |
| PMMA/SiO₂(RX50) | 5.50 | 1.68 | 80.40 | 5.55 | 5.91 |
| (Toluene) | | | | | |
| PMMA(Toluene)/ | 5.57 | 1.80 | 89.02 | | 5.00 |
| SiO₂(RX50) Blend | | | | | |
| PMMA/SiO₂ (RX50) | 5.71 | 1.70 | 46.83 | 3.40 | 4.62 |
| (Toluene-scCO₂) | | | | | |

¹⁾100 × (freed silica weight/hybrid weight)

TABLE 3
Molecular weight and yield of resulting PMMA/silica hybrids
(PMMA/SiO₂(RX50) 5 wt % hybrids)

| | | | | Obserbed silica | Calculated silica |
|---|---|---|---|---|---|
| Sample | Mn × 10⁻⁴ | Mw/Mn | Yeild (%) | content (wt %) | content (wt %)¹⁾ |
| PMMA | 5.57 | 1.80 | 73.45 | — | — |
| (Toluene(10 mL)) | | | | | |
| PMMA/SiO₂(RX50) | 5.50 | 1.68 | 80.40 | 5.55 | 5.91 |
| (Toluene(10 mL)) | | | | | |
| PMMA-SiO₂(RX50) | 5.71 | 1.70 | 46.83 | 3.40 | 4.62 |
| (scCO₂-Toluene(10 mL)) | | | | | |
| PMMA-SiO₂ (RX50) | 7.63 | 1.55 | 48.79 | | 9.70 |
| (scCO₂-Toluene(5 mL)) | | | | | |
| PMMA-SiO₂(RX50) | 8.015 | 1.73 | 81.45 | | 5.62 |
| (scCO₂-(2.5 mL)Toluene) | | | | | |

¹⁾100 × (freed silica weight/hybrid weight)

As can be seen in the table and figures, when comparing the physical properties between different hybrids having Mn about 50,000, the hybrid manufactured using scCO₂ has physical properties superior to those of the hybrid manufactured in toluene solvent. Therefore, it can be understood that MMA was impregnated and polymerized in mesopores of silica by the effect of scCO₂ and PMMA was generated.

### EXAMPLE 5

Manufacturing of PMMA/Nano Silica (50 wt %) Hybrid (PMMA/SiO2(RX50) (scCO₂)) using scCO₂

Methyl methacrylate (MMA) 3.0 g as monomer, dry nano silica (RX50) 1.5 g, and a radical initiator α,α′-azobisisobutyronitrile (AIBN) 0.0492 g were added in a supercritical reaction cell (volume 50 ml), agitated and impregnated at 40° C. under CO₂4 MPa for one hour. The mixture was polymerized at 80° C. under predetermined pressure for 24 hours. After reaction, the reaction mixture was dissolved in acetone 100 ml, dropped into hexane 300 ml. The resulting white sediment was filtered and collected, and dried under reduced pressure (40° C.) until reaching to a constant weight.

### EXAMPLE 6

Manufacturing of PMMA/Nano Silica (50 wt %) Hybrid (PMMA/SiO₂ (RX50) Toluene) using Solvent Toluene

MMA 3.0 g, dry nano silica 1.5 g, AIBN 0.0492 g and toluene 10 ml were added in a reaction container, and reacted under nitrogen atmosphere (normal pressure) at 80° C. for 24 hours.

After reaction, the reaction mixture was dropped into hexane 200 ml. The resulting white sediment was filtered and collected, and dried under reduced pressure (40° C.) until reaching to a constant weight.

### EXAMPLE 7

Manufacturing of Blend (PMMA/SiO₂ (RX50) Blend) of PMMA/Nano Silica (50 wt %) hybrid (PMMA/SiO₂) using Toluene Solvent

(1) PMMA 1.0 g of number average molecular weight 5.17×10⁴ polymerized in the experiment procedure (in toluene solvent) of embodiment 2, and dry nano silica 0.5 g were added into solvent toluene 3.3 ml, and agitated for 24 hours at room temperature.

After reaction, the reaction mixture was dropped into hexane 100 ml, and precipitated. The resulting white sediment was filtered and collected, and dried under reduced pressure (40° C.) until reaching to a constant weight.

(2) PMMA 1.0 g of number average molecular weight 15.8×10⁴ polymerized in the experiment procedure (in scCO₂) of embodiment 1, and dry nano silica 0.5 g were added into solvent toluene 3.3 ml, and agitated for 24 hours at room temperature.

After reaction, the reaction mixture was dropped into hexane 100 ml, and precipitated. The resulting white sediment was filtered and collected, and dried under reduced pressure (40° C.) until reaching to a constant weight.

### EXAMPLE 8

Manufacturing of PMMA/Nano Silica (50 wt %) Hybrid (PMMA/SiO₂ (RX50) scCO₂-Toluene) using Solvent Comprising scCO₂ and Solvent Toluene

MMA 3.0 g, dry nano silica 1.5 g, toluene 10 ml, and AIBN 0.0492 g were added in a supercritical reaction cell (volume 50 ml), agitated and impregnated at 40° C. under CO₂ 4 MPa for one hour. The mixture was polymerized at 80° C. under scCO₂ 10 MPa for 24 hours. After reaction, the reaction mixture was dissolved in acetone 100 ml, and dropped into hexane 300 ml. The resulting white sediment was filtered and collected, and dried under reduced pressure (40° C.) until reaching to a constant weight.

Result 2

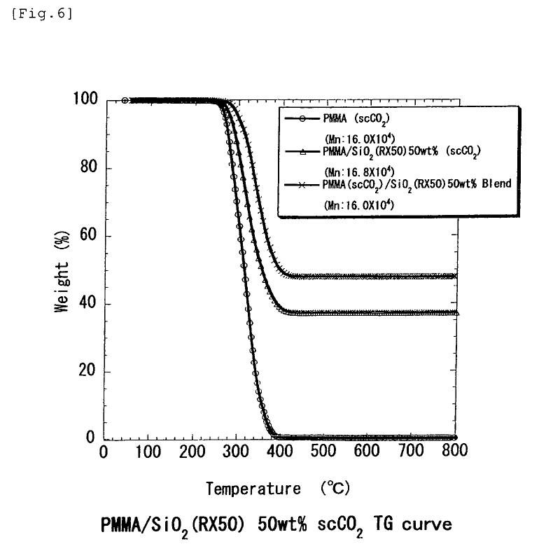

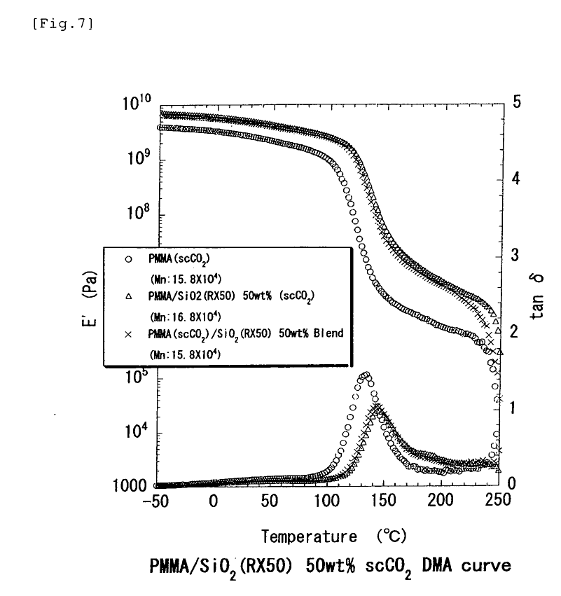

Table 4, and FIGS. 6 and 7 show the molecular weight (Mn), molecular weight distribution (Mw/Mn), yield (%), nano silica content (observed content and calculated content wt %), TG measurement curve and DMA measurement curve of PMMA manufactured without nano silica under experiment condition used in embodiment 5, and those of hybrids containing nano silica 50 wt % manufactured according to embodiments 5 and 7 (2).

TABLE 4
Molecular weight and yield of resulting PMMA/silica hybrids
(PMMA/SiO₂(RX50) 50 wt % hybrids)

| | | | | Obserbed silica | Calculated silica |
|---|---|---|---|---|---|
| Sample | Mn × 10⁻⁴ | Mw/Mn | Yeild (%) | content (wt %) | content (wt %)¹⁾ |
| PMMA | 15.8 | 2.92 | 90.86 | — | — |
| (scCO₂) | | | | | |
| PMMA/SiO₂(RX50) | 16.8 | 2.08 | 77.90 | 39.82 | 56.84 |
| 50 wt % | | | | | |
| (scCO₂) | | | | | |
| PMMA(scCO₂)/ | 15.8 | 2.92 | 74.21 | 47.75 | 44.95 |
| SiO₂(RX50) 50 wt % | | | | | |
| (Blend) | | | | | |

¹⁾100 × (freed silica weight/hybrid weight)

As can be seen in the table and figures, the hybrid manufactured with silica 50 wt % added has improved physical properties. Even with increased content of silica, MMA was impregnated and polymerized in mesopores of silica by the effect of scCO₂ and PMMA was generated.

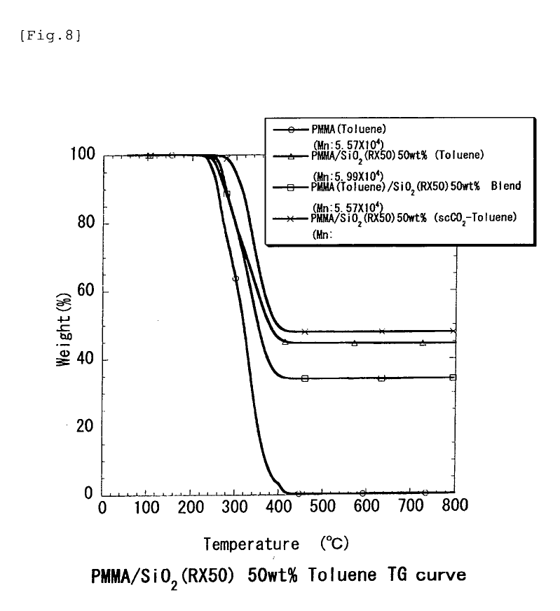

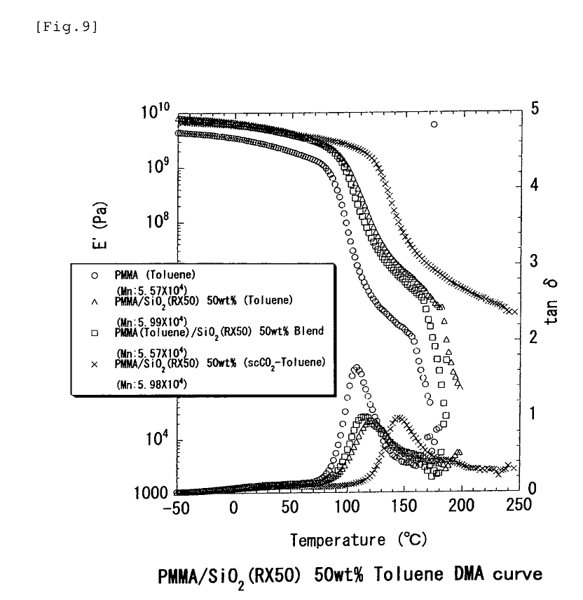

Table 5, and FIGS. 8 and 9 show the molecular weight (Mn), molecular weight distribution (Mw/Mn), yield (%), nano silica content (observed content and calculated content wt %), TG measurement curve and DMA measurement curve of PMMA manufactured without nano silica under experiment condition used in embodiment 5, and those of hybrids containing nano silica 10 wt % manufactured according to embodiments 6, 7(1) and 8.

TABLE 5
Molecular weight and yield of resulting PMMA/silica hybrids
(PMMA/SiO₂(RX50) 50 wt % hybrids)

| | | | | Obserbed silica | Calculated silica |
|---|---|---|---|---|---|
| Sample | Mn × 10⁻⁴ | Mw/Mn | Yeild (%) | content (wt %) | content (wt %)¹⁾ |
| PMMA | 5.57 | 1.80 | 73.45 | — | — |
| (Toluene) | | | | | |
| PMMA/SiO₂(RX50) | 5.99 | 1.734 | 65.34 | 44.36 | 53.69 |
| 50 wt % | | | | | |
| (Toluene) | | | | | |
| PMMA(Toluene)/ | 5.57 | 1.80 | 82.05 | 34.11 | 40.87 |
| SiO₂(RX50)50 wt % | | | | | |
| (Blend) | | | | | |
| PMMA/SiO₂ (RX50) | 5.98 | 1.85 | 66.54 | 47.79 | 48.58 |
| 50 wt % | | | | | |
| (Toluene-scCO₂) | | | | | |

¹⁾100 × (freed silica weight/hybrid weight)

As can be seen in the table and figures, the hybrid manufactured with silica 50 wt % added has improved physical properties. When comparing the physical properties between different hybrids having Mn about 50,000, the hybrid manufactured using scCO₂ has physical properties superior to those of the hybrid manufactured in toluene solvent. Therefore, it can be understood that MMA was impregnated and polymerized in mesopores of silica by the effect of scCO₂ and PMMA was generated.

### EXAMPLE 9

Manufacturing of PMMA/Alumina (5 wt %) Hybrid (PMMA/Al₂O₂ (33 nm) (scCO₂)) using scCO₂

Methyl methacrylate (MMA) 3.0 g as monomer, alumina 0.15 g, and radical initiator α,α′-azobisisobutyronitrile (AIBN) 0.0492 g were added in a supercritical reaction cell (volume 50 ml), agitated and impregnated at 40° C. under CO₂ 4 MPa for one hour. The mixture was polymerized at 80° C. under predetermined pressure for 24 hours.

After reaction, the reaction mixture was dissolved in acetone 100 ml, and dropped into hexane 300 ml. The resulting white sediment was filtered and collected, and dried under reduced pressure (40° C.) until reaching to a constant weight.

### EXAMPLE 10

Manufacturing of PMMA/Alumina (5 wt %) Hybrid (PMMA/Al₂O₂ (33 nm) (Toluene)) using Solvent Toluene

MMA 3.0 g, alumina 0.15 g, AIBN 0.0492 g and toluene 10 ml were added into a reaction container, and reacted under nitrogen atmosphere (normal pressure) at 80° C. for 24 hours.

After reaction, the reaction mixture was dropped into hexane 200 ml. The resulting white sediment was filtered and collected, and dried under reduced pressure (40° C.) until reaching to a constant weight.

### EXAMPLE 11

Manufacturing of Blend (PMMA/Al₂O₂ (33 nm) (Blend)) of PMMA/Alumina (5 wt %) Hybrid (PMMA/Al₂O₂) using Toluene

Similar to embodiment 9, PMMA 1.0 g of number average molecular weight 16.0×10⁴ polymerized in scCO₂ and dry nano alumina 0.05 g were added into solvent toluene 3.3 ml, and agitated for 24 hours at room temperature.

After reaction, the reaction mixture was dropped into hexane 100 ml and precipitated. The resulting white sediment was filtered and collected, and dried under reduced pressure (40° C.) until reaching to a constant weight.

Similar to embodiment 11, PMMA 1.0 g of number average molecular weight 5.57×10⁴ polymerized in toluene solvent and dry alumina 0.05 g were added into solvent toluene 3.3 ml, and agitated for 24 hours at room temperature.

After reaction, the reaction mixture was dropped into hexane 100 ml and precipitated. The resulting white sediment was filtered and collected, and dried under reduced pressure (40° C.) until reaching to a constant weight.

### EXAMPLE 12

Manufacturing of PMMA/Alumina (5 wt %) Hybrid (PMMA/Al₂O₂ (33 nm) (Toluene-scCO₂)) using Solvent Comprising scCO₂ and Solvent Toluene

MMA 3.0 g, alumina 0.15 g, toluene 10 ml, and AIBN 0.0492 g were added in a supercritical reaction cell (volume 50 ml), agitated and impregnated at 40° C. under CO₂ 4 MPa for one hour. The mixture was polymerized at 80° C. under predetermined pressure for 24 hours.

After reaction, the reaction mixture was dissolved in acetone 100 ml, and dropped into hexane 300 ml. The resulting white sediment was filtered and collected, and dried under reduced pressure (40° C.) until reaching to a constant weight.

The results of resulting PMMA/alumina hybrids were summarized in Tables 6 and 7.

TABLE 6
Molecular weight and yield of resulting
PMMA/aluminous hybrids
(PMMA/Al₂O₃(33 nm) 5 wt % hybrids)

| | | | | Observed | Calculated |
|---|---|---|---|---|---|
| | | | | alumina | alumina |
| Sample | Mn × 10⁻⁴ | Mw/Mn | Yeild (%) | content (wt %) | content (wt %)¹⁾ |
| PMMA | 5.91 | 1.875 | 73.45 | — | — |
| (Toluene) | | | | | |
| PMMA/Al₂O₃(33 nm) | 5.98 | 1.848 | 82.71 | 7.17 | 5.78 |
| (Toluene) | | | | | |
| PMMA(Toluene)/ | 5.91 | 1.875 | 91.02 | 5.12 | 5.00 |
| Al₂O₃(33 nm) Blend | | | | | |
| PMMA/Al₂O₃(33 nm) | 4.24 | 2.11 | 67.69 | 4.93 | 4.77 |
| (Toluene-scCO₂) | | | | | |

¹⁾100 × (freed silica weight/hybrid weight)

TABLE 7
Molecular weight and yield of resulting
PMMA/aluminous hybrids
(PMMA/Al₂O₃(33 nm) 5 wt % hybrids)

| | | | | Observed | Calculated |
|---|---|---|---|---|---|
| | | | | alumina | alumina |
| Sample | Mn × 10⁻⁴ | Mw/Mn | Yeild (%) | content (wt %) | content (wt %)¹⁾ |
| PMMA | 12.0 | 2.675 | 86.37 | — | — |
| (scCO₂) | | | | | |
| PMMA/Al₂O₃(33 nm) | 15.8 | 1.691 | 89.07 | 6.91 | 5.52 |
| 5 wt % | | | | | |
| (scCO₂) | | | | | |
| PMMA(scCO₂)/ | 12.0 | 2.675 | 92.7 | 4.04 | 5.0 |
| Al₂O₃(33 nm)5 wt % | | | | | |
| (Blend) | | | | | |

¹⁾100 × (freed silica weight/hybrid weight)

### INDUSTRIAL APPLICABILITY

As described above, the polymer/nano (alumina) hybrid material according to the invention is prepared by impregnating monomer in the nanometer order holes of a nano material by supercritical carbon dioxide fluid, and by polymerizing it in situ. Therefore, the polymer composite has a network structure in which polymers penetrate in nano pores.

Therefore, the material has utterly novel properties such as high clarity, high heat-resistance, and high hardness.

The novel material features remarkably excellent properties which have not been predicted from the physical properties of the conventional materials known in the art. As such, the novel material can solve many outstanding problems which have not long been solved in the existing polymer composites (general polymer material).

The material according to the invention has wide applications in various technical fields including, home appliances, electronics, automobiles, architecture, optics, aerospace instruments, and many other fields. Therefore, the material will have high marketability.

What is claimed:

1. A porous nano material polymer composite wherein polymer penetrates into nano pores of nano silica to form network structure.

2. The porous nano material polymer composite according to claim 1, wherein the polymer is polymethyl methacrylate (PMMA).

3. A manufacturing method of porous nano material polymer composite, the method comprising, impregnating monomer in nanometer order holes of a porous nano material in supercritical carbon dioxide fluid, and polymerizing the monomer.
